(19) United States
(12) Patent Application Publication
(10) Pub. No.: US 2007/0097577 A1
(43) Pub. Date: May 3, 2007

(54) Electric power supplying apparatus and image forming apparatus

(76) Inventors: Youbao Peng, Tokyo (JP); Utami Soma, Tokyo (JP); Atsushi Takahashi, Tokyo (JP)

Correspondence Address: CANTOR COLBURN, LLP, 55 GRIFFIN ROAD SOUTH, BLOOMFIELD, CT, 06002, US

(21) Appl. No.: 11/505,504

(22) Filed: Aug. 17, 2006

(30) Foreign Application Priority Data
Oct. 27, 2005 (JP) JP2005-312745

(51) Int. Cl. H02H 3/08

(52) U.S. Cl. 361/93.1

(57) ABSTRACT

There is described an apparatus, which supply AC electric powers fed from a plurality of commercial electric power sources to an electric power loading section, so as to supply an amount of electric power exceeding a maximum rated electric power fed from one of the commercial electric power sources. The apparatus, includes: AC power inputting ports that are respectively coupled to AC power sources, so as to simultaneously introduce various kinds of AC electric power units from the AC power sources; an electric power combining section to combine the AC electric power units, supplied from the AC power sources, with each other, so as to generate a combined electric power, serving as a single electric power source; and a combined electric power outputting port that is coupled to an electric power load section in order to supply the combined electric power to the electric power load section.

This application is based on Japanese Patent Application No. 2005-312745 filed on Oct. 27, 2005 in Japanese Patent Office, the entire content of which is hereby incorporated by reference.

### BACKGROUND OF THE INVENTION

The present invention relates to an electric power supplying apparatus that supplies alternate current electric power (hereinafter, referred to as AC electric power for simplicity), supplied from a plurality of alternate current electric power sources (hereinafter, referred to as AC power sources for simplicity), to an electric power loading section, and an image forming apparatus that is provided with an electric power supplying section concerned.

Generally speaking, when the image forming apparatus, such as a laser printer, a copier, etc., outputs a print based on image data, a toner image developed on a photoreceptor drum based on the image data is transferred onto a recording medium, such as a paper sheet, etc., and then, the transferred toner image is fixed onto the recording medium by applying heat and pressure to the toner image by employing a fixing device heated by a heating section, so as to form the image on the recording medium concerned. In the image forming apparatus provided with the fixing device mentioned in the above, the electric power consumption for heating the heating device (the electric power loading section), such as an induction coil, etc., is getting large, and associated with the large-sizing trend of image forming apparatus having a high-speed capability and an enhanced functions, the electric power consumption of such the image forming apparatus has been increasing rapidly in recent years. Generally speaking, an amount of the electric power available for the image forming apparatus (rated electric power) is determined at a predetermined value, and an amount of the electric power to be supplied to the heating device and other electric power loading sections is limited within a range of the available amount of the electric power (the predetermined rated electric power).

Conventionally, a method for increasing an input voltage or an input current, or an electric power code, having a large capacity of the electric current to be flew per one code, is employed for the power supply section of the electric apparatus whose electric power consumption is relatively large, such as the image forming apparatus mentioned in the above. In the abovementioned cases, however, since the input terminal and/or the electric power code should be changed to larger capacity one, the scale of the modification of the electric power facility would be getting larger at the place where the electric apparatus is to be installed, resulting in the adverse problem for changing the apparatus to new one. To solve the abovementioned problem, for instance, Patent document 1 and Patent document 2 (Tokkai 2003-244359 and Tokkai 2005-121681, both are Japanese Non-Examined Patent Publications) set forth the technology for dividing the plural electric power loading sections, which are provided in the image forming apparatus proper, into several blocks corresponding to the functions, so as to independently supply the AC electric power, fed from each of the plural commercial power sources (AC electric power sources), to each of the blocks.

According to the technology set forth in Patent document 1 and Patent document 2 (Tokkai 2003-244359 and Tokkai 2005-121681), however, since the AC electric power, fed from each of the plural commercial power sources, is independently supplied to each of the blocks, the amount of the electric power consumption of the block concerned cannot exceed the maximum electric power to be fed from one of the plural commercial power sources, sometimes, resulting in an inability of supplying a sufficient electric power necessary for the electric power loading section concerned.

### SUMMARY OF THE INVENTION

To overcome the abovementioned drawbacks in conventional image forming apparatus, it is an object of the present invention to provide an electric power supplying apparatus and an image forming apparatus, which supply AC electric powers fed from a plurality of commercial electric power sources to an electric power loading section, while make it possible to supply an amount of electric power exceeding a maximum rated electric power fed from one of the plurality of commercial electric power sources.

Accordingly, to overcome the cited shortcomings, the abovementioned object of the present invention can be attained by electric power supplying apparatus and image forming apparatus described as follow.
(1) An electric power supplying apparatus, comprising: a plurality of AC power inputting ports that are respectively coupled to a plurality of AC power sources, so as to simultaneously introduce various kinds of AC electric power units from the plurality of AC power sources; an electric power combining section to combine the AC electric power units, supplied from the plurality of AC power sources, with each other, so as to generate a combined electric power, serving as a single electric power source; and a combined electric power outputting port that is coupled to an electric power load section in order to supply the combined electric power to the electric power load section.
(2) An image forming apparatus, comprising: a fixing section to fix a toner image formed on a recording medium; an electromagnetic induction heating device to heat the fixing section by employing an electromagnetic induction heating action; and an electric power supplying section to supply electric powers fed from a plurality of AC power sources, serving as commercial electric power sources, to the electro-magnetic induction heating device and another electric power load section; wherein the electric power supplying section includes: a plurality of AC power inputting ports that are respectively coupled to the plurality of AC power sources, so as to simultaneously introduce various kinds of AC electric power units from the plurality of AC power sources; and an electric power combining section to combine the AC electric power units, supplied from the plurality of AC power sources, with each other, so as to generate a combined electric power, serving as a single electric power source; and a combined electric power outputting port that is coupled to the electric power load section in order to supply the combined electric power to the electric power load section.
(3) An electric power supplying apparatus, characterized in that the electric power supplying apparatus is provided with an electric power combining section to combine AC electric powers supplied from a plurality of AC power sources into a single electric power so as to supply the single electric power to an electric power load section.

### BRIEF DESCRIPTION OF THE DRAWINGS

Other objects and advantages of the present invention will become apparent upon reading the following detailed description and upon reference to the drawings in which:

FIG. 1 shows an internal configuration of an electric apparatus embodied in the present invention;

FIG. 2 shows a configuration of an image forming section and a fixing device of the image forming apparatus embodied in the present invention;

FIG. 3 shows an IH heater incorporated in an inside space of a fixing roller;

FIG. 4 shows an internal configuration of an image forming apparatus embodied in the present invention;

FIG. 5 shows an internal configuration of AC/DC converters provided in an electric power combining section as a first embodiment of the present invention;

FIG. 6 shows an internal configuration of AC/DC converters provided in an electric power combining section as a second embodiment of the present invention;

FIG. 7 shows a flowchart of an electric power limit controlling operation embodied in the present invention; and

FIG. 8 shows an example of an electric power controlling sequence conducted during the warm-up operating period.

### DETAILED DESCRIPTION OF THE PREFERRED EMBODIMENT

Referring to the drawings, as the best mode of the present invention, the preferred embodiment will be detailed in the following. However, the scope of the present invention is not limited to the examples shown in the drawings.

### First Embodiment

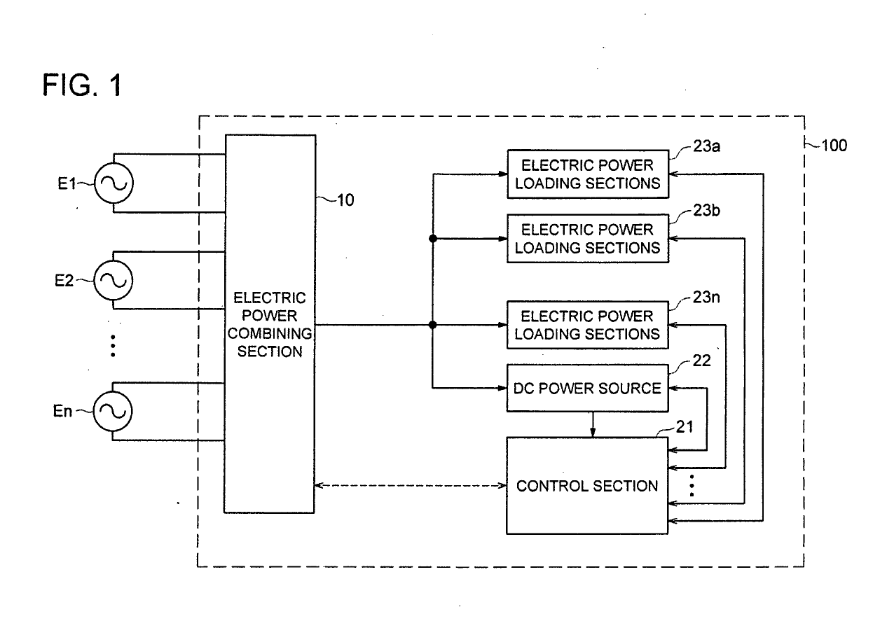

Initially, referring to FIG. 1, the internal configuration of an electric apparatus 100 provided with an electric power supplying apparatus embodied in the present invention.

As shown in FIG. 1, the electric apparatus 100, serving as the electric power supplying apparatus, is provided with an electric power combining section 10, a control section 21, a DC power source 22, electric power loading sections 23, etc.

The electric power combining section 10 combines AC electric powers, fed from a plurality of commercial power sources (AC power sources) E1-En (where, “n” represents a natural number), with each other so as to generate a single electric power to be supplied into the DC power source 22 and the electric power loading sections 23. Incidentally, in the present embodiment, the maximum amount of electric power fed from each of the plurality of commercial power sources E1-En is assumed at 100V/15 Amax. However, the value of the maximum amount of electric power is not limited to the above.

The control section 21 is constituted by a CPU (Central Processing Unit), a ROM (Read Only Memory), a RAM (Random Access Memory), etc., in order to totally control the whole system of the electric apparatus 100 by executing the system programs stored in the ROM based on the various kinds of setting values read from the ROM. Further, the control section 21 also controls amounts of electric powers to be supplied into the electric power loading sections 23 corresponding to the operating statuses of the electric power loading sections 23.

The DC power source 22 converts the voltage of the DC electric power, generated by combining the plural AC electric powers in the electric power combining section 10, to a predetermined voltage value, so as to supply the DC electric power having the converted voltage to the control section 21.

The electric power loading sections 23 corresponds to various kinds of functional sections, each of which consumes electric power to achieve a predetermined functional goal (for instance, such as a heating device for raising a temperature, etc.), and is constituted by a plurality of electric power loading sections 23a-23n. Hereinafter, the plurality of electric power loading sections 23a-23n are totally called the electric power loading sections 23. Incidentally, although the electric power loading sections 23 includes the plurality of electric power loading sections 23a-23n in the present embodiment, the scope of the present invention is not limited to the above, and a single electric power loading section is also applicable in the present invention.

The case in which an image forming apparatus is exemplified as the electric apparatus 100 will be detailed in the following. However, it is needless to say that the scope of the electric apparatus 100 is not limited to the above.

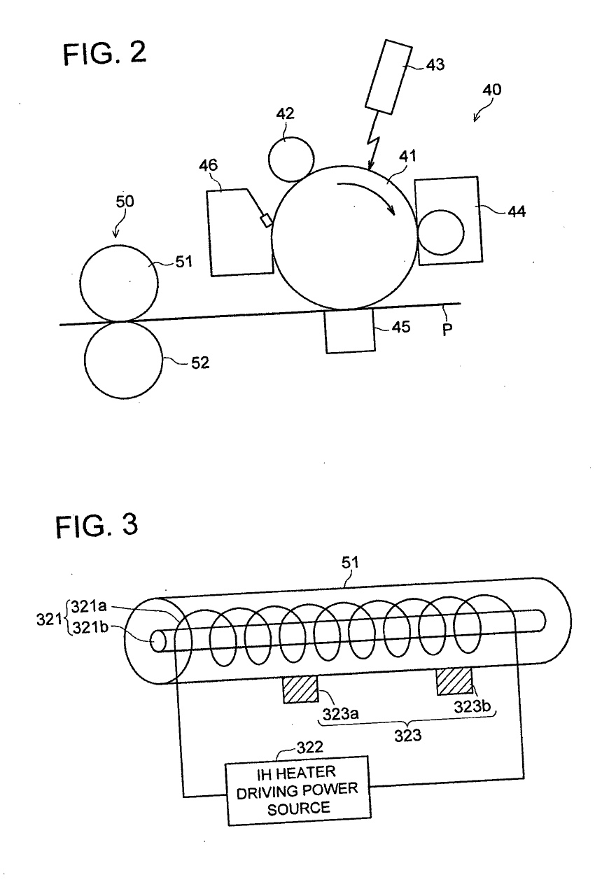

At first, referring to FIG. 2 and FIG. 3, brief configurations of an image forming section 40 and a fixing device 50 equipped in an image forming apparatus 200 will be explained in the following.

As shown in FIG. 2, the image forming section 40 is provided with a photoreceptor drum 41, a charging device 42 for charging the photoreceptor drum 41, an exposing section 43 for applying an exposing operation onto the photoreceptor drum 41, a developing device 44 for developing a latent image formed on the photoreceptor drum 41 with toner, a transferring section 45 for transferring the toner image developed on the photoreceptor drum 41 onto a paper sheet P and a cleaning device 46 for cleaning residual toner remained on the surface of the photoreceptor drum 41.

When the paper sheet P is conveyed to the image forming section 40, the circumferential surface of the photoreceptor drum 41 is uniformly charged at a predetermined electric potential by the charging device 42, and then, exposed by the exposing section 43 so as to form a latent image on the circumferential surface of the photoreceptor drum 41. Then, the latent image is developed with toner, so as to form a toner image, serving as a visible image, on the photoreceptor drum 41. Further, the transferring section 45 transfers the toner image formed on the photoreceptor drum 41 onto the paper sheet P conveyed to the photoreceptor drum 41, and after the transferring operation is completed, the residual toner remained on the photoreceptor drum 41 are removed by the cleaning device 46, in order to reuse the photoreceptor drum 41 for the next image forming operation.

On the other hand, the paper sheet P, bearing the toner image through the abovementioned process, is conveyed from the photoreceptor drum 41 to the fixing device 50 in which the unfixed toner image is fixed onto the paper sheet P, so as to form a print image on the paper sheet P.

The fixing device 50 is provided with a fixing roller 51 serving as a heating member including an induction heating heater 321 (electro-magnetic Induction Heating: hereinafter, referred to as an IH heater 321, for simplicity) and a pressure roller 52 serving as a pressing member that press-contacts the fixing roller 51 so as to form a fixing nip portion.

As shown in FIG. 3, the fixing roller 51 incorporates the IH heater 321 in its inside space. The IH heater 321 includes an induction coil 321a and a core member 321b made of the magnetic material and disposed at a center of the inside space, so as to serve as a heating source for the fixing roller 51. Concretely speaking, the induction coil 321a is activated by the AC current supplied from an IH heater driving power source 322, so as to diverge alternate magnetic fluxes, being periodically changing, from the induction coil 321a. The generated alternate magnetic fluxes induce induction currents in the fixing roller 51 so that Joule losses of the induction currents generate heat for heating the fixing roller 51. Incidentally, it is also applicable that the IH heater 321 includes a plurality of induction coils.

A temperature sensor 323a and a temperature sensor 323b (hereinafter, also referred to as a temperature sensor 323, as a total name for both of them) are disposed at the fixing roller 51 in a contacting state, or in the vicinity of the fixing roller 51, and temperature detecting signals outputted from the temperature sensor 323 are inputted into the control section 21.

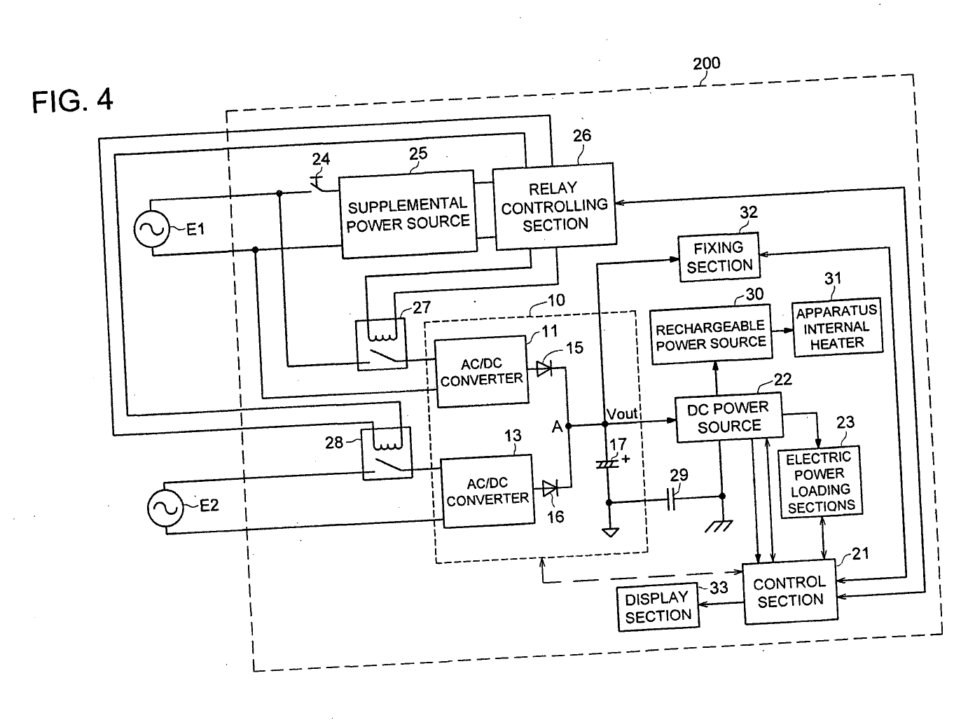

FIG. 4 shows an internal configuration of the image forming apparatus 200. Incidentally, for the sake of the simplicity of the explanation, the same reference numbers are attached to the elements being same as those shown in FIG. 1, and detailed explanations of them will be omitted as needed, in the following.

As shown in FIG. 4, the image forming apparatus 200 is provided with the electric power combining section 10, the control section 21, the DC power source 22, the electric power loading sections 23, a power switch 24, a supplemental power source 25, a relay controlling section 26, a relay 27, a relay 28, a capacitor 29, a rechargeable power source 30, an apparatus internal heater 31, a fixing section 32, a display section 33, etc.

The a power switch 24 is used for turning ON/OFF the flow of AC electric power from the commercial power sources El and E2 into the image forming apparatus 200 by the operator. The supplemental power source 25 converts the AC electric power fed from the commercial power sources El to the DC electric power, so as to output the converted DC electric power to the relay controlling section 26. The relay controlling section 26 turns ON the relay 27 and the relay 28 when the electric power is supplied from the supplemental power source 25. The relay 27 outputs the AC electric power, fed from the commercial power source El under the controlling operation of the relay controlling section 26, to an AC/DC converter 11 in the electric power combining section 10. Further, the relay 28 outputs the AC electric power, fed from the commercial power source E2 under the controlling operation of the relay controlling section 26, to a AC/DC converter 13 in the electric power combining section 10.

The electric power combining section 10 is constituted by the AC/DC converter 11, the AC/DC converter 13, a rectifying diode 15, a rectifying diode 16 and a capacitor 17. The a AC/DC converter 11 converts the AC electric power fed from the commercial power sources El through the relay 27 to the DC electric power, so as to output the converted DC electric power through the rectifying diode 15. The a AC/DC converter 13 converts the AC electric power fed from the commercial power sources El through the relay 28 to the DC electric power, so as to output the converted DC electric power through the rectifying diode 16. The capacitor 17 is used for smoothing the DC electric powers outputted from the AC/DC converter 11 and the AC/DC converter 13 through the rectifying diode 15 and the rectifying diode 16. The DC electric powers, outputted from the AC/DC converter 11 and the AC/DC converter 13 through the rectifying diode 15 and the rectifying diode 16, are combined with each other at a DC output port “A” of the AC/DC converter 11 and the AC/DC converter 13, so as to output a single DC electric power Vout to the DC power source 22 and the fixing section 32.

The control section 21 is constituted by a CPU, a ROM, a RAM, etc. in order to totally control the whole system of the image forming apparatus 200 by executing the system programs stored in the ROM based on the various kinds of setting values read from the ROM.

The control section 21 outputs a control signal (IH_CONT signal) for instructing the supply of the driving electric power for heating the IH heater 321 to the IH heater driving power source 322 and another control signal (IH_POWER command signal) for instructing the amount of electric power to be supplied. Concretely speaking, the control section 21 generates the IH_POWER command signal for adjusting the heating temperature, based on the temperature detecting signals inputted from the temperature sensor 323, and outputs the IH_POWER command signal to the IH heater driving power source 322. Then, the IH heater driving power source 322 supplies an amount of electric power corresponding to the control signals sent from the control section 21, so as to adjusts the heating temperature of the IH heater 321.

The DC power source 22 converts a current voltage value of the single DC electric power Vout combined in the electric power combining section 10 to the predetermined voltage value, and supplies the converted single DC electric power Vout to the control section 21, the electric power loading sections 23 and the rechargeable power source 30. The electric power loading sections 23 includes a plurality of functional sections for implementing the total operation of the image forming apparatus 200, which are driven by the single DC electric power Vout. Incidentally, a grounding port of the capacitor 17 (common grounding) is coupled to a grounding port of the DC power source 22 (connected to the outside case) through the capacitor 29.

The rechargeable power source 30 is constituted by an electric double layer capacitor, etc., to charge a predetermined amount of the DC electric power fed from the DC power source 22, so as to supply the charged DC electric power to the apparatus internal heater 31. The apparatus internal heater 31, serving as a heating device, such as a heating lump, etc., heats the predetermined portion in the image forming apparatus 200 corresponding to the DC electric power supplied from the rechargeable power source 30.

The fixing section 32 is constituted by the IH heater 321 for heating the fixing roller 51, the IH heater driving power source 322 for supplying the driving electric power to the IH heater 321 based on the single DC electric power Vout supplied from the electric power combining section 10, the temperature sensor 323 for detecting the temperatures of the fixing roller 51 so as to output the detected results to the control section 21, etc.

The display section 33 is constituted by a display device, such as a CRT (Cathode Ray Tube), a LCD (Liquid Crystal Display), an organic or inorganic ELD (Electro Luminescence Display), etc., so as to display various kinds of images, based on the various kinds of display data inputted under the controlling operations conducted by the control section 21, on its screen.

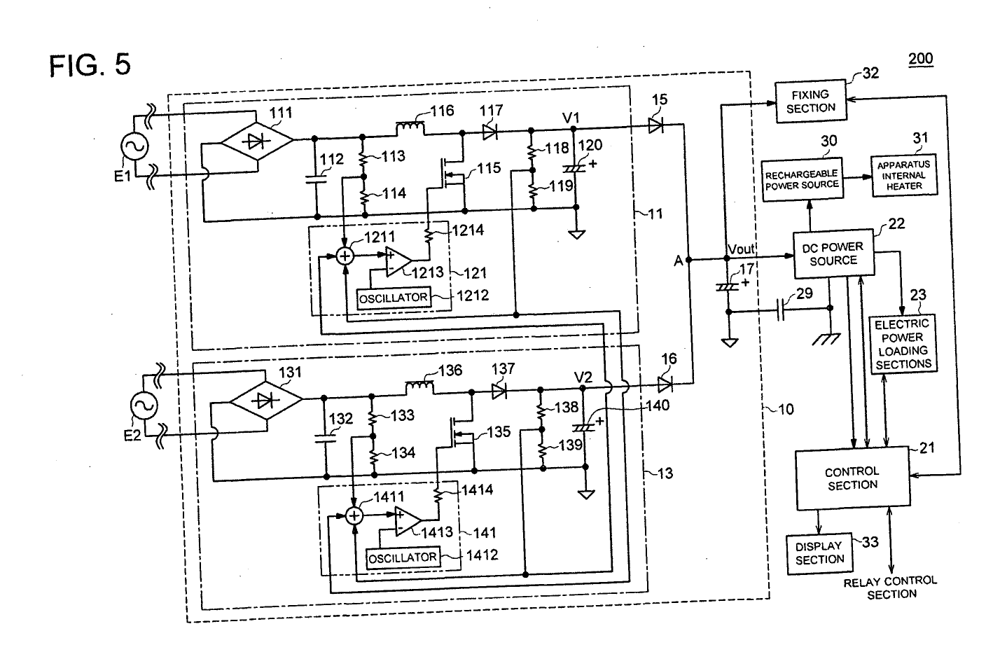

FIG. 5 shows an internal configuration of the AC/DC converter 11 and the AC/DC converter 13. Initially, the AC/DC converter 11 will be detailed in the following.

As shown in FIG. 5, the AC/DC converter 11 is constituted by a rectifying bridge 111, a capacitor 112, a resistor 113, a resistor 114, a switching element 115, a boosting coil 116, a rectifying diode 117, a resistor 118, a resistor 119, a capacitor 120, and a control IC 121, etc.

The rectifying bridge 111 rectifies the AC electric power fed from the commercial power source E1 so as to output the rectified DC electric power to the boosting coil 116. The capacitor 112 is coupled in parallel to the output ports of the rectifying bridge 111 so as to smooth the back electromotive force generated by the boosting coil 116 and apply it to the output ports of the rectifying bridge 111. A potential divider constituted by the resistor 113 and the resistor 114 is coupled to the output ports of the rectifying bridge 111 so as to output a divided voltage (hereinafter, referred to as a divided voltage 1) to an adding device 1211 of the control IC 121, detailed later.

The switching element 115 intermittently interrupts the DC electric power to be inputted into the boosting coil 116 under the controlling operation of the control IC 121 detailed later. The back electromotive force, generated in the boosting coil 116 by the electric power controlling action of the switching element 115, is rectified by the rectifying diode 117, and then, smoothed by the capacitor 120, so as to output it through the rectifying diode 15. A potential divider constituted by the resistor 118 and the resistor 119 is coupled to the output ports of the rectifying diode 117 so as to output a divided voltage (hereinafter, referred to as a divided voltage 2) to both the adding device 1211 of the control IC 121 detailed later and an adding device 1411 of a control IC 141 detailed later.

The control IC 121 is constituted by the adding device 1211, an oscillator 1212, a comparator 1213, a resistor 1214, etc. The adding device 1211 adds the divided voltage 1, the divided voltage 2 and a divided voltage 4 sent from the AC/DC converter 13 detailed later to output the added voltage to the comparator 1213. The oscillator 1212 generates (oscillates) signals having a pulse-like waveform, such as a triangle waveform, a rectangular waveform, etc., and output the generated signals to the comparator 1213. The comparator 1213 compares the signals outputted by the oscillator 1212 with the added voltage inputted from the adding device 1211 so as to generate PWM (Pulse Width Modulation) waveform signals. Since the output port of the comparator 1213 is coupled to the switching element 115 through the resistor 1214, the intermittent interrupting actions performed by the switching element 115 are controlled on the basis of the PWM (Pulse Width Modulation) waveform signals so as to control the electric power flew into the boosting coil 116. In this operation, the control IC 121 controls the switching element 115 so that a voltage value V1 of the DC electric power boosted by the boosting coil 116 becomes equal to a voltage value V2 of the DC electric power outputted from the AC/DC converter 13.

Next, the AC/DC converter 13 will be detailed in the following.

As shown in FIG. 5, the AC/DC converter 13 is constituted by a rectifying bridge 131, a capacitor 132, a resistor 133, a resistor 134, a switching element 135, a boosting coil 136, a rectifying diode 137, a resistor 138, a resistor 139, a capacitor 140, the control IC 141, etc., and has the configuration same as that of the AC/DC converter 11.

The rectifying bridge 131 rectifies the AC electric power fed from the commercial power source E2 so as to output the rectified DC electric power to the boosting coil 136. The capacitor 132 is coupled in parallel to the output ports of the rectifying bridge 131 so as to smooth the back electromotive force generated by the boosting coil 136 and apply it to the output ports of the rectifying bridge 131. A potential divider constituted by the resistor 133 and the resistor 134 is coupled to the output ports of the rectifying bridge 131 so as to output a divided voltage (hereinafter, referred to as a divided voltage 3) to the adding device 1411 of the control IC 141, detailed later.

The switching element 135 intermittently interrupts the DC electric power to be inputted into the boosting coil 136 under the controlling operation of the control IC 141 detailed later. The back electromotive force, generated in the boosting coil 136 by the electric power controlling action of the switching element 135, is rectified by the rectifying diode 137, and then, smoothed by the capacitor 140, so as to output it through the rectifying diode 16. A potential divider constituted by the resistor 138 and the resistor 139 is coupled to the output ports of the rectifying diode 137 so as to output a divided voltage (hereinafter, referred to as a divided voltage 4) to both the adding device 1411 of the control IC 141 detailed later and the adding device 1211 of a control IC 121 mentioned in the above.

The control IC 141 is constituted by the adding device 1411, an oscillator 1412, a comparator 1413, a resistor 1414, etc. The adding device 1411 adds the divided voltage 3, the divided voltage 4 and a divided voltage 2 sent from the AC/DC converter 11 mentioned in the above to output the added voltage to the comparator 1413. The oscillator 1412 generates (oscillates) signals having a pulse-like waveform, such as a triangle waveform, a rectangular waveform, etc., and output the generated signals to the comparator 1413. The comparator 1413 compares the signals outputted by the oscillator 1412 with the added voltage inputted from the adding device 1411 so as to generate PWM (Pulse Width Modulation) waveform signals. Since the output port of the comparator 1413 is coupled to the switching element 135 through the resistor 1414, the intermittent interrupting actions performed by the switching element 135 are controlled on the basis of the PWM (Pulse Width Modulation) waveform signals so as to control the electric power flew into the boosting coil 136. In this operation, the control IC 141 controls the switching element 1350so that the voltage value V2 of the DC electric power boosted by the boosting coil 136 becomes equal to the voltage value V1 of the DC electric power outputted from the AC/DC converter 11.

The DC electric powers outputted from the AC/DC converter 11 and the AC/DC converter 13 are combined at the DC output port “A” of the both converters, and inputted as the single DC electric power Vout into the DC power source 22 and the fixing section 32.

In the abovementioned configuration, the AC electric powers fed from the commercial power sources E1 and E2 are converted to the DC electric powers whose voltages are equal to each other under the controlling actions conducted by the control IC 121 of the AC/DC converter 11 and the control IC 141 of the AC/DC converter 13, both of which are provided in the electric power combining section 10. Then, the converted DC electric powers are combined into the single DC electric power Vout at the DC output port “A” of both the AC/DC converter 11 and the AC/DC converter 13, so that the single DC electric power Vout is supplied to each of the electric power loading sections (such as the DC power source 22, the electric power loading sections 23, the apparatus internal heater 31, the fixing section 32, etc.). Further, the control section 21 controls the operations of each of the electric power loading sections, in order to achieve the total operation of the image forming apparatus 200. Incidentally, it is preferable that the control section 21 conducts a power controlling operation, so as to keep a total amount of the electric power to be supplied to each of the electric power loading sections at a level lower than the rated voltage established in advance.

As described in the foregoing, according to the embodiment of the present invention, since the AC electric powers fed from the plurality of commercial power sources can be combined into a single electric power so as to supply the combined single electric power to the electric power loading sections, it becomes possible to supply the electric power, exceeding the maximum electric power being suppliable from one of the plurality of commercial power sources, to the electromagnetic induction heating device and the other electric power loading sections, provided in the image forming apparatus.

### Second Embodiment

Next, the second embodiment of the present invention will be detailed in the following. Incidentally, for the sake of the simplicity of the explanation, the same reference numbers are attached to the elements being same as those of the first embodiment, and detailed explanations of them will be omitted in the following as needed.

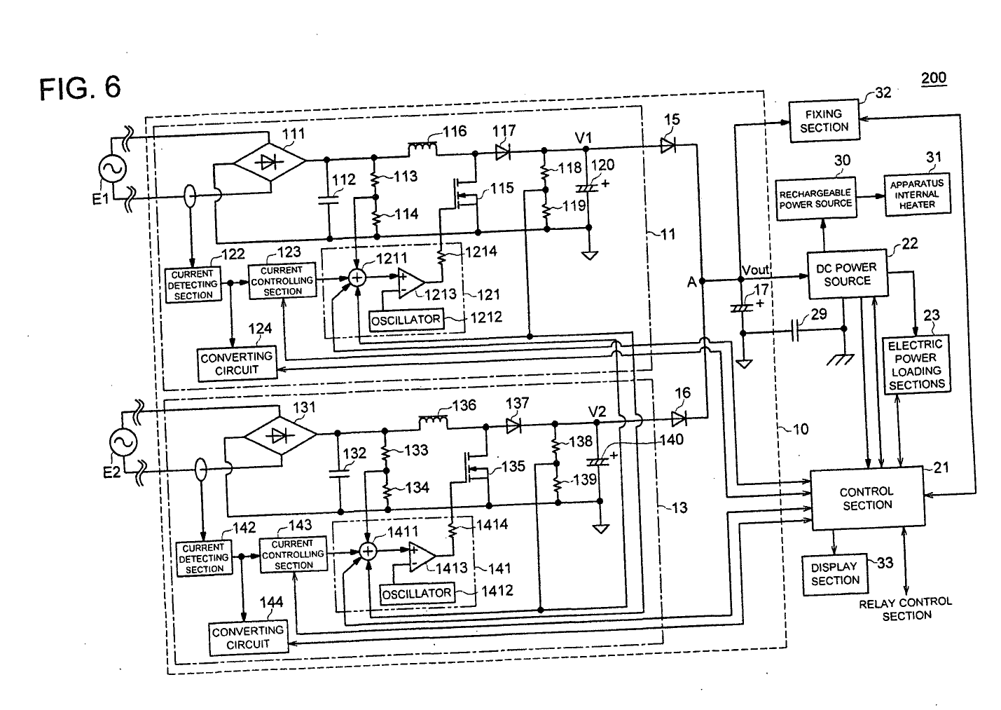

At first, referring to FIG. 6, the internal configuration of the electric power combining section 10 in the second embodiment will be detailed in the following.

As shown in FIG. 6, in addition to the aforementioned configuration shown in FIG. 5, the AC/DC converter 11 is further provided with a current detecting section 122, a current controlling section 123 and a converting circuit 124.

The current detecting section 122 includes a current transformer, etc., to detect an electric current of the AC electric power fed from the commercial power source El and output the current detected signal to both the current controlling section 123 and the converting circuit 124.

The current controlling section 123 compares a current value I1 of the current detected signal inputted from the current detecting section 122 with a current limit value established in advance and stored in the current controlling section 123 (for instance, 15A), to output a comparison result voltage based on the comparison result to the adding device 1211. The comparison result voltage as well as the divided voltage 1, the divided voltage 2, the divided voltage 4 mentioned in the above, is inputted into the adding device 1211, so as to add them each other and to output the added voltage to the comparator 1213. The comparator 1213 compares the signals outputted by the oscillator 1212 with the added voltage inputted from the adding device 1211 so as to generate PWM (Pulse Width Modulation) waveform signals. By driving the switching element based on the generated PWM waveform signals, the current value of the input current is adjusted to the current limit value mentioned in the above.

In the above configuration, the current limit value of the current controlling section 123 can be established corresponding to a control signal sent from the control section 21. For instance, it is applicable that that the current limit value can be established corresponding to the operating statuses of the electric power loading sections 23, the apparatus internal heater 31, the fixing section 32, etc. For instance, the maximum current value of the electric power fed from the commercial power source E1 (15A) or a predetermined current value lower than the maximum current value (hereinafter, referred to as a limiter current value) can be established as the current limit value to be established in the current controlling section 123.

The converting circuit 124 includes an analogue-to-digital converter, a photo-interrupter, etc., in order to convert the current detected signal inputted from the current detecting section 122 to a predetermined instruction signal, and outputs it to the control section 21. Based on the current value instructed by the instruction signal, the control section 21 controls the amount of electric power to be supplied from the DC power source 22 and the fixing section 32 (IH heater driving power source 322).

As shown in FIG. 6, in addition to the aforementioned configuration shown in FIG. 5, the AC/DC converter 13 is further provided with a current detecting section 142, a current controlling section 143 and a converting circuit 144.

The current detecting section 142 includes a current transformer, etc., to detect an electric current of the AC electric power fed from the commercial power source E2 and output the current detected signal to both the current controlling section 143 and the converting circuit 144.

The current controlling section 143 compares a current value I2 of the current detected signal inputted from the current detecting section 142 with a current limit value established in advance (for instance, 5A), to output a comparison result voltage based on the comparison result to the adding device 1411. The comparison result voltage as well as the divided voltage 3, the divided voltage 4, the divided voltage 2 mentioned in the above, is inputted into the adding device 1411, so as to add them each other and to output the added voltage to the comparator 1413. The comparator 1413 compares the signals outputted by the oscillator 1412 with the added voltage inputted from the adding device 1411 so as to generate PWM (Pulse Width Modulation) waveform signals. By driving the switching element based on the generated PWM waveform signals, the current value of the input current is adjusted to the current limit value mentioned in the above.

In the above configuration, the current limit value of the current controlling section 143 can be established corresponding to a control signal sent from the control section 21. For instance, it is applicable that that the current limit value can be established corresponding to the operating statuses of the electric power loading sections 23, the apparatus internal heater 31, the fixing section 32, etc.

The converting circuit 144 includes an analogue-to-digital converter, a photo-interrupter, etc., in order to convert the current detected signal inputted from the current detecting section 142 to a predetermined instruction signal, and outputs it to the control section 21. Based on the current value instructed by the instruction signal, the control section 21 controls the amount of electric power to be supplied from the DC power source 22 and the fixing section 32 (IH heater driving power source 322). In addition, when the input current exceeds the current limit value established in the converting circuit 144, the control section 21 deactivates the whole operation of the image forming apparatus 200.

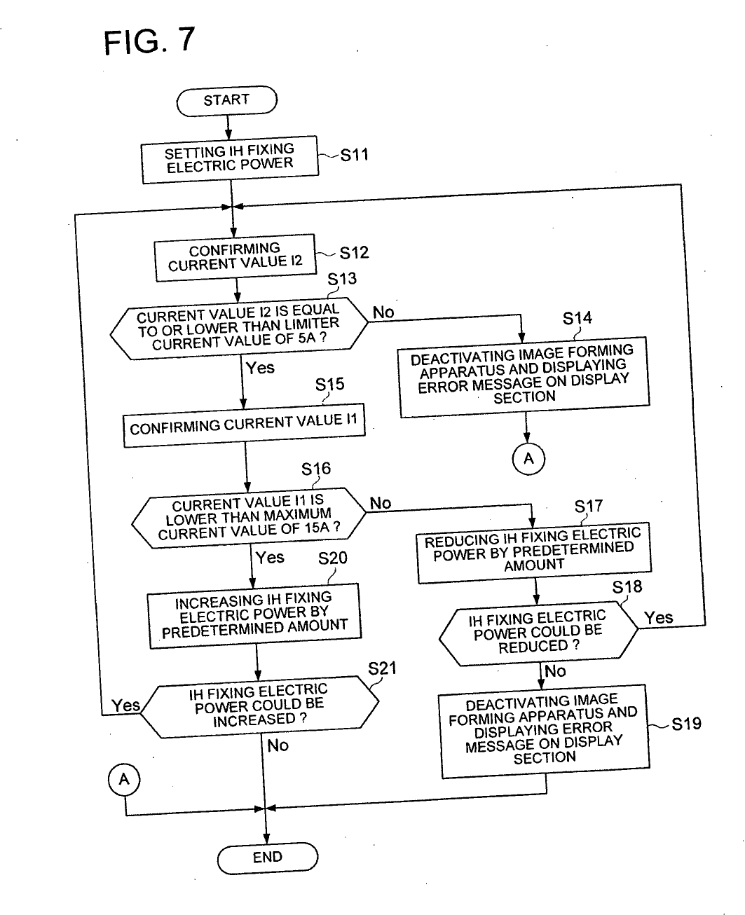

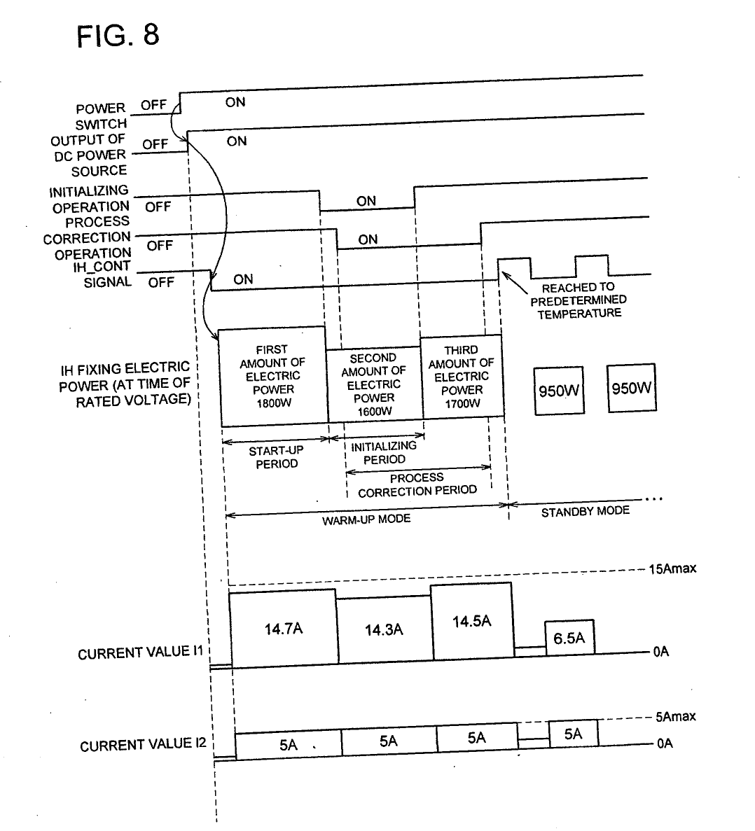

Next, referring to FIG. 7 and FIG. 8, the electric power limit controlling operation to be conducted at a starting time (during a warm-up period) of the image forming apparatus 200 will be detailed in the following. Incidentally, as a premise of this operation, it is assumed that the maximum current value of 15A and the limiter current value of 5A are established in the current controlling section 123 and the current controlling section 143, respectively. Further, it is also assumed that the rated electric power of the image forming apparatus 200 is AC100V/20 Amax.

FIG. 7 shows a flowchart of the electric power limit controlling operation in regard to the electric power to be supplied into the IH heater driving power source 322 (hereinafter, referred to as an IH fixing electric power). Incidentally, in this flowchart, the control section 21 conducts each of the actions included in the electric power limit controlling operation. Further, this operation is conducted either continuously or periodically at predetermined intervals during the activating time of the image forming apparatus 200.

The flowchart of the electric power limit controlling operation, shown in FIG. 7, includes the steps of: setting the IH fixing electric power as a predetermined value (Step S11); confirming the current value I2 based on the instruction signal sent from the converting circuit 144 (Step S12); determining whether or not the current value I2 is equal to or lower than the limiter current value of 5A (Step S13); deactivating the whole operation of the image forming apparatus 200 and displaying a message indicating “OCCURRENCE OF ERROR” on a screen of the display section (Step S14), when determining that the current value I2 exceeds the limiter current value of 5A (Step S13, No); and finalizing the electric power limit controlling operation (END). Incidentally, it is preferable that the value of the IH fixing electric power to be established in Step S11 is the maximum amount of electric power being suppliable under a current status, considering the electric power consumptions in the electric power loading sections 23, etc.

The flowchart of the electric power limit controlling operation, shown in FIG. 7, further includes the steps of: confirming the current value I1 based on the instruction signal sent from the converting circuit 124 (Step S15), when determining that the current value 12 is equal to or lower than the limiter current value of 5A (Step S13, Yes); determining whether or not the current value I1 is lower than the maximum current value of 15A (Step S16); reducing the IH fixing electric power by a predetermined amount (Step S17), when determining that the current value I1 is equal to or higher than the maximum current value of 15A (Step S16, No); determining whether or not the IH fixing electric power could be reduced while maintaining the normal operating state of the image forming apparatus 200 (Step S18); returning to Step S12, when determining that the IH fixing electric power could be successfully reduced in Step S18; deactivating the whole operation of the image forming apparatus 200 and displaying a message indicating “OCCURRENCE OF ERROR” on a screen of the display section (Step S19), when determining that the IH fixing electric power could not be successfully reduced (Step S18, No); and finalizing the electric power limit controlling operation (END).

The flowchart of the electric power limit controlling operation, shown in FIG. 7, further includes the steps of: increasing the IH fixing electric power by a predetermined amount (Step S20), when determining that the current value I1 is lower than the maximum current value of 15A (Step S16, Yes); determining whether or not the IH fixing electric power could be increased (Step S21); returning to Step S12, when determining that the IH fixing electric power could be successfully increased in Step S21; and finalizing the electric power limit controlling operation (END) and outputting the IH electric power instruction signal for instructing the amount of electric power established in Step S20 to the IH heater driving power source 322, when determining that the IH fixing electric power could not be successfully increased in Step S21.

FIG. 8 shows an example of the electric power controlling sequence conducted by the IH heater driving power source 322 during the warm-up operating period.

As shown in FIG. 8, when the operator turns ON the power switch 24, the electric power supply from the DC power source 22 is enabled so that the electric power is supplied to the control section 21 from the DC power source 22. Then, the control section 21 outputs the IH_CONT signal, for commencing the operation for supplying the electric power to the IH heater 321, and the IH electric power instruction signal, for instructing the amount of the electric power derived from the electric power limit controlling operation mentioned in the above, to the IH heater driving power source 322 as the control signals.

At first, the control section 21 commences a pre-operation (start-up term in the drawing) prior to the initializing operation, and outputs the control signal for instructing the IH fixing electric power (1800 W), derived from the electric power limit controlling operation mentioned in the above as the IH fixing electric power to be supplied to the IH heater, to the IH heater driving power source 322. In response to the control signal, the IH heater driving power source 322 supplies the corresponding amount of electric power to the IH heater 321. Incidentally, hereinafter, the term of a “process correction” is defined as various kinds of correcting operations for obtaining a stable image, such as a registration correction of an image to be formed, a density correction of the image, etc. FIG. 8 indicates that the current value I1, which is detected during the pre-operation prior to the initializing operation, is 14.7 A, while the current value I2 is 5A.

During the implementation of the initializing operation and the process correction operation after the pre-operation prior to the initializing operation is completed (during the ON state of them), based on an amount of electric power derived by substituting the amount of electric power necessary for the initializing operation and the process correction operation, the control section 21 outputs the control signal for instructing the IH fixing electric power (1600 W), derived from the electric power limit controlling operation mentioned in the above, to the IH heater driving power source 322, so that the IH heater driving power source 322 supplies the amount of electric power corresponding to the control signal to the IH heater 321. FIG. 8 indicates that the current value I1, which is detected during the pre-operation prior to the initializing operation, is 14.3 A, while the current value I2 is 5 A.

During the implementation of only the process correction operation after the initializing operation is completed (during the ON state of the process correction operation and the OFF state of the initializing operation), based on an amount of electric power derived by substituting the amount of electric power necessary for the process correction operation, the control section 21 outputs the control signal for instructing the IH fixing electric power (1700 W), derived from the electric power limit controlling operation mentioned in the above, to the IH heater driving power source 322, so that the IH heater driving power source 322 supplies the amount of electric power corresponding to the above control signal to the IH heater 321. FIG. 8 indicates that the current value I1, which is detected during the pre-operation prior to the initializing operation, is 14.5 A, while the current value I2 is 5A.

Since then, at the time when the IH heater 321 has heated the fixing roller 51 up to the predetermined temperature set as the target value in the mid-course of supplying the IH fixing electric power (1700 W), the control section 21 outputs the control signal for turning OFF the IH_CONT signal to the IH heater driving power source 322, so as to deactivate the operation for supplying the electric power to the IH heater 321. Successively from the warm-up mode, the image forming apparatus 200 enters into a standby mode in which the control section 21 intermittently outputs the control signal, for supplying the predetermined IH fixing electric power (950 W) into the IH heater 321, to the IH heater driving power source 322. FIG. 8 indicates that the current value I1, which is detected during the pre-operation prior to the initializing operation, is 6.5 A, while the current value I2 is 5 A.

In the configuration described in the foregoing, the AC electric powers fed from the commercial power sources E1 and E2 are converted to the DC electric powers having the same voltage under the controlling operations of the control ICs 121, 141 of the AC/DC converters 11, 13 provided in the electric power combining section 10, respectively. Then, the DC electric powers having the same voltage are combined into the single DC electric power Vout, which is supplied to each of the electric power loading sections including the DC power source 22, the electric power loading sections 23, the apparatus internal heater 31, the fixing section 32, etc. Further, the total operation of the image forming apparatus 200 is achieved by supplying an appropriate amount of electric power to each of the electric power loading sections, corresponding to a current operating status of each of the electric power loading sections, under the controlling operations conducted by the control section 21.

As described in the foregoing, according to the embodiments of the present invention, since the AC electric powers supplied from the plurality of commercial power sources can be combined into the single electric power, which is supplied to the electric power loading sections, it becomes possible to supply the amount of electric power, which exceeds the maximum electric power being suppliable from one of the plurality of commercial power sources (AC power sources), to the electromagnetic induction heating device and the other electric power loading sections, which are provided in the image forming apparatus. Specifically, although the electromagnetic induction heating device consumes a relatively large amount of electric power, it becomes possible to stably supply the electric power to the electromagnetic induction heating device, resulting in a stable implementation of the image forming operations.

Further, since it is possible to control the amount of electric power to be supplied to the fixing section 32 and the electric power loading sections 23, so that the total amount of electric power consumed in the fixing section 32 and the electric power loading sections 23 is equal to or lower than a predetermined value and the rated electric power of the image forming apparatus 200, it becomes possible to safely supply the electric power to the electric power loading sections 23 (including the fixing section 32.).

The details of the configurations and the operations of the aforementioned embodiments can be varied by a skilled person without departing from the spirit and scope of the invention.

For instance, although two commercial power sources are employed for the image forming apparatus 200 aforementioned as the embodiment of the present invention, the number of commercial power sources to be employed for the image forming apparatus is not limited to the above, but it is applicable to employ an arbitral number of them. In this case, the electric power combining section 10 is provided with a plurality of AC/DC converters, each of which corresponds to each of the commercial power sources.

Further, although the boosting coil 116 and the boosting coil 136 are employed as the voltage converting element in the aforementioned embodiment of the present invention, it is also applicable that a step-down coil (step-down transformer) is employed for this purpose, instead of the boosting coil.

Further, although the IH heater 321 is employed as the heating device of the fixing roller 51 in the aforementioned embodiment of the present invention, it is also applicable that either a halogen heater or a ceramic heater is employed for this purpose.

### MODIFIED EXAMPLE

Incidentally, in the embodiment described in the foregoing, although the image forming apparatus, which employs the IH heater 321 for the heating device of the fixing roller 51, is exemplified as the electric apparatus 100, the scope of the electric apparatus 100 is not limited to the above. For instance, the present invention can be also applied to a medium-sized image forming apparatus (or a medium-sized printing apparatus), which is operated in a normal office environment for producing a relatively small amount of print products. In such the case, by implementing the present invention for the image forming apparatus, namely by supplying the necessary electric power to the image forming apparatus form a plurality of wall outlets equipped in the office, it becomes possible to effectively solve the problem for satisfying the electric power capacity of the image forming apparatus in the office. Further, it is also applicable that the abovementioned image forming apparatus is a color or monochrome printing apparatus or a copier, which employs the electro-photographic method (and/or employs the tandem method or the other method).

In the case that a plurality of optional devices, such as paper feeder, etc., serving as a pre-processing apparatus, a stapler, a puncher, a folder, etc., serving as a post-processing apparatus, are coupled to (or included in) the image forming apparatus to form an integrated image forming system, it is possible to combine a plurality of AC electric powers fed from a plurality of commercial power sources, which are respectively coupled to the plurality of optional devices, into a single electric power so as to supply the single electric power to the electric power loading sections of the image forming apparatus concerned. It is needless to say that the abovementioned image forming system is also included in the scope of the present invention.

As described in the foregoing, according to the present invention, the following effects can be attained.
(1) Since the AC electric powers supplied from a plurality of AC electric power sources can be combined into a single electric power so as to supply the combined single electric power to the electric power loading section, it becomes possible to supply an amount of electric power exceeding a maximum rated electric power fed from one of the plurality of commercial electric power sources.
(2) Since, by respectively converting the AC electric power units, supplied from the plurality of AC power sources, into DC electric power units and by coupling output ports of the DC electric power units to the single electric power line, the AC electric powers supplied from a plurality of AC electric power sources can be combined into a single electric power so as to supply the combined single electric power to the electric power loading section, it becomes possible to supply an amount of electric power exceeding a maximum rated electric power fed from one of the plurality of commercial electric power sources.
(3) Since it is possible to make the DC voltages of the plurality of DC electric power units coincide with each other, it becomes possible to easily combine the plurality of DC electric power units.
(4) Since the AC input current can be controlled so as to limit the AC input current to a value equal to or lower than the current limit value established in advance, it becomes possible to limit the current value of the DC electric power to be outputted from the AC-to-DC converting section to a value equal to or lower than the DC current limit value.
(5) Since the current limit value can be adjusted, it becomes possible to establish the current limit value corresponding to the service conditions, the operating environments, etc.
(6) Since the amount of the combined electric power, corresponding to a current operation status of the electric power load section, can be supplied to the electric power load section, it becomes possible to improve the efficiency of the electric power supply.
(7) Since the combined electric power can be controlled so as to limit a total amount of the combined electric power, to be supplied to the electric power load section, to a value equal to or lower than a predetermined value, when the rated electric power is established, it becomes possible to limit a total amount of the combined electric power to a value equal to or lower than the rated electric power established, and as a result, it also becomes possible to safely supply the electric power to the electric power load section.

Since the AC electric powers supplied from a plurality of AC electric power sources can be combined into a single electric power so as to supply the combined single electric power to the electric power loading section, it becomes possible to supply an amount of electric power, exceeding a maximum rated electric power fed from one of the plurality of commercial electric power sources (namely, AC electric power sources), to the electromagnetic induction heating device and the other electric power loading sections provided in the image forming apparatus. Specifically, despite that the electro-magnetic induction heating device consumes a relatively large amount of electric power, it becomes possible to stably supply the electric power to the electro-magnetic induction heating device concerned, resulting in a stable implementation of the image forming operations.

While the preferred embodiments of the present invention have been described using specific term, such description is for illustrative purpose only, and it is to be understood that changes and variations may be made without departing from the spirit and scope of the appended claims.

What is claimed is:

1. An electric power supplying apparatus, comprising:
a plurality of AC power inputting ports that are respectively coupled to a plurality of AC power sources, so as to simultaneously introduce various kinds of AC electric power units from the plurality of AC power sources;
an electric power combining section to combine the AC electric power units, supplied from the plurality of AC power sources, with each other, so as to generate a combined electric power, serving as a single electric power source; and
a combined electric power outputting port that is coupled to an electric power load section in order to supply the combined electric power to the electric power load section.

2. The electric power supplying apparatus of claim 1,
wherein the electric power combining section includes:
a plurality of AC-to-DC converting sections to respectively convert the AC electric power units, supplied from the plurality of AC power sources, into DC electric power units; and
a DC power combining circuit to couple output ports of the DC electric power units to the combined electric power outputting port, serving as a single electric power line, so as to combine the DC electric power units into the combined electric power.

3. The electric power supplying apparatus of claim 2,
wherein each of the plurality of AC-to-DC converting sections includes:
a DC voltage changing section to increase or decrease a DC voltage of a DC electric power unit concerned, being one of the DC electric power units; and
a DC voltage controlling section to control the DC voltage changing section so that the DC voltage of the DC electric power unit coincides with that of another DC electric power unit.

4. The electric power supplying apparatus of claim 2,
wherein each of the plurality of AC-to-DC converting sections includes:
an input current detecting section to detect an amount of AC input current supplied from corresponding one of the plurality of AC power inputting ports; and
a current controlling section to control the AC input current so as to limit the AC input current to a value equal to or lower than a current limit value established in advance, based on the amount of AC input current detected by the input current detecting section.

5. The electric power supplying apparatus of claim 4,
wherein each of the plurality of AC-to-DC converting sections further includes:
a current limit value adjusting section to adjust the current limit value.

6. The electric power supplying apparatus of claim 1, further comprising:
an electric power controlling section to control an amount of the combined electric power to be supplied to the electric power load section, corresponding to a current operation status of the electric power load section.

7. The electric power supplying apparatus of claim 6,
wherein the electric power controlling section controls the combined electric power, so as to limit a total amount of the combined electric power, to be supplied to the electric power load section, to a value equal to or lower than a predetermined value.

8. An image forming apparatus, comprising:
a fixing section to fix a toner image formed on a recording medium;
an electromagnetic induction heating device to heat the fixing section by employing an electromagnetic induction heating action; and
an electric power supplying section to supply electric powers fed from a plurality of AC power sources, serving as commercial electric power sources, to the electromagnetic induction heating device and another electric power load section;
wherein the electric power supplying section includes:
a plurality of AC power inputting ports that are respectively coupled to the plurality of AC power sources, so as to simultaneously introduce various kinds of AC electric power units from the plurality of AC power sources;
an electric power combining section to combine the AC electric power units, supplied from the plurality of AC power sources, with each other, so as to generate a combined electric power, serving as a single electric power source; and
a combined electric power outputting port that is coupled to the electric power load section in order to supply the combined electric power to the electric power load section.

9. The image forming apparatus of claim 8,
wherein the electric power combining section includes:
a plurality of AC-to-DC converting sections to respectively convert the AC electric power units, supplied from the plurality of AC power sources, into DC electric power units; and
a DC power combining circuit to couple output ports of the DC electric power units to the combined electric power outputting port, serving as a single electric power line, so as to combine the DC electric power units into the combined electric power.

10. The image forming apparatus of claim 9,
wherein each of the plurality of AC-to-DC converting sections includes:
a DC voltage changing section to increase or decrease a DC voltage of a DC electric power unit concerned, being one of the DC electric power units; and
a DC voltage controlling section to control the DC voltage changing section so that the DC voltage of the DC electric power unit coincides with that of another DC electric power unit.

11. The image forming apparatus of claim 9,
wherein each of the plurality of AC-to-DC converting sections includes:
an input current detecting section to detect an amount of AC input current supplied from corresponding one of the plurality of AC power inputting ports; and
a current controlling section to control the AC input current so as to limit the AC input current to a value equal to or lower than a current limit value established in advance, based on the amount of AC input current detected by the input current detecting section.

12. The image forming apparatus of claim 11, wherein each of the plurality of AC-to-DC converting sections further includes:
a current limit value adjusting section to adjust the current limit value.

13. The image forming apparatus of claim 8, wherein the electric power supplying section further comprises:
an electric power controlling section to control an amount of the combined electric power to be supplied to the electric power load section, corresponding to a current operation status of the electric power load section.

14. The image forming apparatus of claim 13, wherein the electric power controlling section controls the combined electric power, so as to limit a total amount of the combined electric power, to be supplied to the electric power load section, to a value equal to or lower than a predetermined value.

15. An electric power supplying apparatus, characterized in that
the electric power supplying apparatus is provided with an electric power combining section to combine AC electric powers supplied from a plurality of AC power sources into a single electric power so as to supply the single electric power to an electric power load section.
